(19) United States
(12) Patent Application Publication
(10) Pub. No.: US 2012/0244301 A1
(43) Pub. Date: Sep. 27, 2012

(54) COMPONENT WITH A HOLLOW BODY THAT CAN BE SUBJECTED TO INTERNAL PRESSURE

(75) Inventor: Andreas RADTKE, Mannheim (DE)

(73) Assignee: BASF SE, Ludwigshafen (DE)

(21) Appl. No.: 13/425,517

(22) Filed: Mar. 21, 2012

Related U.S. Application Data
(60) Provisional application No. 61/466,020, filed on Mar. 22, 2011.

(51) Int. Cl. B32B 1/02; B32B 5/02; B32B 27/04

(52) U.S. Cl. 428/34.5; 428/35.7; 428/36.1

(57) ABSTRACT

The invention relates to a component comprising a hollow body that can be subjected to internal pressure, where the hollow body that can be subjected to internal pressure is open at least on one side and at least one aperture extends in an axial direction. The hollow body has been manufactured from a continuous-fiber-reinforced thermoplastic polymer, where the continuous fibers have a high degree of orientation and have not been arranged peripherally in the hollow body.

The invention is based on a component comprising a hollow body that can be subjected to internal pressure and that is open at least on one side.

Hollow bodies that can be subjected to internal pressure and that are open at least on one side are used by way of example in motor vehicle construction. Hollow bodies of this type serve by way of example as receptacles for airbags. Other examples of hollow bodies that can be subjected to internal pressure and that are open on one side, and that are used in automobile construction, are cylinder-head covers.

The general manufacturing method currently used for hollow bodies that can be subjected to internal pressure and that are open on one side, and that are used for airbags or as cylinder-head covers, uses designs involving sheet steel. Another alternative known method uses plastics components, for example glass-fiber-reinforced polyamide or glass-fiber-reinforced polypropylene with wall thicknesses in the range from 2 to 5 mm. The glass fibers used in the glass-fiber-reinforced plastics, for example in the glass-fiber-reinforced polyamide or glass-fiber-reinforced polypropylene are generally short glass fibers or long glass fibers with length up to 10 mm.

In order that the hollow bodies can be subjected to internal pressure it is necessary to reinforce the external side thereof, in particular when the bodies used are composed of plastic. The hollow bodies are reinforced here by using add-on reinforcement ribs. However, this has the disadvantage that firstly the overall size of the parts increases and secondly additional weight is introduced.

The increase in weight is undesirable in particular in view of desired reductions in fuel consumption, since a weight increase always leads to increased fuel consumption. It is therefore desirable that the individual components manufactured for the vehicle have minimum weight. However, when components are designed using steel it is difficult to reduce weight simply because of the density of the material, since it is not generally possible to make any further reduction in the amount of material used. When fiber-reinforced plastics are used, it is again difficult to make any further reduction in the weight of material used, since, particularly in the case of hollow bodies that can be subjected to internal pressure, these plastics have to have sufficient stability to withstand the internal pressure. Particularly in the case of cylinder-head covers, the internal pressure involved moreover constantly changes, and there is therefore also a requirement here for adequate resistance to pressure variations.

If the hollow body that can be subjected to internal pressure is used as receptacle for an airbag, although the hollow body is only subjected to internal pressure on one occasion, when the airbag is triggered, there is a requirement again here for adequate stability to ensure full functioning capability of the airbag.

It is therefore an object of the present invention to provide a component which has a hollow body that can be subjected to internal pressure and which has lower weight than the components known from the prior art, and provides adequate resistance to internal pressure.

The object is achieved via a component comprising a hollow body that can be subjected to internal pressure, where the hollow body that can be subjected to internal pressure is open at least on one side and at least one aperture extends in an axial direction, where the hollow body has been manufactured from a continuous-fiber-reinforced thermoplastic polymer, and the continuous fibers have not been arranged peripherally in the hollow body.

The use of a continuous-fiber-reinforced thermoplastic polymer permits production of hollow bodies that can be subjected to internal pressure and that have a wall thickness which is markedly below the wall thickness of fiber-reinforced polymers currently used. The use of the continuous fibers provides adequate stability even when wall thicknesses are less than 2 mm. Another advantage of the use of a thermoplastic polymer is that it is easy to connect the hollow body, open on one side, to further components, e.g. covers. The connection here can by way of example be achieved via a welding process. It is also possible, for example by using an injection-molding process, to mold further elements onto the hollow body that can be subjected to internal pressure, made of the continuous-fiber-reinforced thermoplastic polymer. This allows production of stable components and secure fixing of the add-on parts to a hollow body that can be subjected to internal pressure.

The term organopanels is also used for the continuous-fiber-reinforced thermoplastic polymers used as components with high length and width and with a thickness that is very small in comparison therewith.

The continuous fibers in the organopanel have a high degree of orientation, unlike those in conventional fiber-reinforced polymers. For the purposes of the present invention, a high degree of orientation means that the continuous fibers are in essence parallel or are nonparallel at any desired angle, preferably a right angle. When the fibers are nonparallel, the respective individual fibers of one layer are likewise in essence parallel.

Hollow bodies that can be subjected to internal pressure are usually produced as closed bodies, for example in the form of cylinders, within which the continuous fibers have been arranged peripherally. However, hollow bodies of this type cannot be used for all applications. In particular in the case of an airbag module, by way of example, there is a requirement for an aperture which extends in an axial direction. However, this type of aperture extending in an axial direction prevents peripheral arrangement of the continuous fibers used.

For the purposes of the present invention the term continuous fibers is used for fibers which extend continuously from one end of the hollow body to the opposite end of the hollow body. Particularly, if the hollow body takes the form of a hollow cylinder with an aperture extending in an axial direction formed therein, at least a portion of the fibers extends from one side of the aperture extending in an axial direction through the hollow body to the opposite side of the aperture extending in an axial direction. This gives a radial arrangement of the fibers. The form assumed by the hollow body can however be not only a cylindrical shape with an aperture extending in an axial direction but also any desired other form that is technically necessary. By way of example, therefore, a half-shell in any desired form is also a hollow body which is open at least on one side, where at least one aperture extends in an axial direction.

Suitable thermoplastic polymers which can be used in order to manufacture the hollow body are polyolefins, such as polyethylene or polypropylene; polyamides, such as nylon-6, nylon-6,6, nylon-6,12; polycarbonates, and by way of example thermoplastic polyurethanes, polyoxymethylene, polyphenylene ether; styrene polymers, such as polystyrene and copolymers comprising styrene, e.g. acrylonitrile-butadiene-styrene copolymers and styrene-acrylonitrile copolymers; polytetrafluoroethylene, polyaromatics, such as polyphenylene sulfide, polyether sulfone, polysulfone, polyether ether ketone, polyetherimide, polyacrylate, or polyamideimide; polyquioxalines, polyquinolines, or polybenzimidazoles; polyesters, such as polyethylene terephthalate or polybutylene terephthalate; polyacrylonitrile, or polyvinyl compounds, such as polyvinyl chloride, polyvinylidene chloride, polyvinyl ester, such as polyvinyl acetate, polyvinyl alcohols, polyvinyl acetals, polyvinyl ethers, polyvinyl lactams, polyvinylamines, and also mixtures thereof.

Suitable polymers are selected here to correspond to the desired use of the hollow body that can be subjected to internal pressure. Preference is given to the following thermoplastic polymers: polyethylene, polypropylene, polyamides, polyethylene terephthalate, polybutylene terephthalate, polycarbonate, and thermoplastic polyurethane.

By way of example, therefore, examples of preferred materials for hollow bodies that can be subjected to internal pressure and that are used as airbag housings are polypropylene and polyamide. For cylinder-head covers preference is given to, by way of example, polyamides.

Examples of fibers which can be used as continuous fibers for hollow bodies that can be subjected to internal pressure are glass fibers, carbon fibers, potassium titanate fibers, mineral fibers, such as basalt fibers, boron fibers, and aramid fibers. The fibers are comprised in the form of woven, knit, or laid scrim, preferably in the form of long parallel fibers, in the continuous-fiber-reinforced thermoplastic polymers. If the continuous fibers are comprised in the form of woven, it is possible to use any desired woven known to the person skilled in the art.

If the fibers are comprised in the form of plies of parallel fibers within the continuous-fiber-reinforced thermoplastic polymers, it is preferable that the continuous fibers are comprised in a plurality of plies made of parallel fibers, where the fibers of the individual plies are not parallel to one another. There can be any desired angle between the individual plies here. It is preferable that the angle between the individual plies is in the range from 45 to 90°, preferably in the range from 80 to 90°, and in particular 90°.

In order to obtain adequate resistance to the internal pressure, the proportion of fibers in the continuous-fiber-reinforced thermoplastic polymer is preferably at least 30% by weight. In order to obtain adequate resistance of the continuous-fiber-reinforced thermoplastic polymer, the maximum proportion of fibers is 70% by weight.

The thickness of the continuous-fiber-reinforced thermoplastic polymers is selected as a function of the internal pressure that may arise within the hollow body. The higher the possible internal pressure, the greater the load on the hollow body. A greater thickness of the thermoplastic polymer is therefore required if the load is correspondingly greater. The stress to which the continuous-fiber-reinforced thermoplastic polymer is subjected is also greater when the polymer is subjected to an oscillating load. If a load occurs on only one occasion it is necessary to select the wall thickness in such a way that the hollow body withstands this load.

A suitable thickness of the continuous-fiber-reinforced polymers is up to 5 mm, preferably in the range from 0.5 to 4 mm, in particular in the range from 1 to 3 mm.

Particularly if the component with the hollow body that can be subjected to internal pressure is used at a high temperature, particularly at temperatures in the vicinity of the melting point of the thermoplastic polymer used, it is preferable to add suitable additives to the thermoplastic polymer for heat-stabilization. An example of an additive that can be used for heat-stabilization is iron powder or a combination of Cu-containing stabilizers with iron oxides. If a polyamide is used it is particularly preferable to use a polyamide which comprises from 10 to 99.999% by weight of a polyamide, from 0.001 to 20% by weight of iron powder with a particle size of at most 10 μm (d₅₀ value), and from 0 to 70% by weight of further additional materials.

The iron powder can by way of example be obtained via thermal decomposition of pentacarbonyl iron preferably at temperatures of from 150 to 350° C. The resultant particles preferably have a spherical shape, i.e. are spherical or almost spherical. Iron content is preferably from 97 to 99.8 g/100 g, in particular from 97.5 to 99.6 g/100 g. Content of other metals is preferably less than 1000 ppm, more preferably less than 100 ppm, and in particular less than 10 ppm. Nitrogen content in the iron powder is preferably at most 1.5 g/100 g, in particular from 0.01 to 1.2 g/100 g, and oxygen content is preferably at most 1.3 g/100 g, in particular from 0.3 to 0.65 g/100 g.

Preferred heat-stabilized polyamides comprise from 20 to 98% by weight, in particular from 25 to 94% by weight, of a polyamide, such as PA 4, PA 6, PA 7, PA 8, PA 9, PA 11, PA 12, PA 46, PA 66, PA 69, PA 610, PA 612, PA 613, PA 1212, PA 1313, PA 6T, PA 9T, PA MXD6, PA 61, PA 6-3-T, PA 6/6T, PA 6/66, PA 6/12, PA 66/6/610, PA 6I/6T, PA PACM 12, PA 6I/6T/PACM, PA 12/MACMI, PA 12/MACMT, PA PDA-T.

The proportion of iron powder is preferably in the range from 0.05 to 10% by weight and in particular in the range from 0.1 to 5% by weight.

The following materials can also be comprised as additional materials alongside the continuous fibers, and can also be comprised in the other abovementioned polymers, fibrous or particulate fillers, such as carbon fibers, glass fibers, glass beads, amorphous silica, calcium silicate, calcium metasilicate, magnesium carbonate, kaolin, chalk, powdered quartz, mica, barium sulfate, and/or feldspar, in amounts of from 1 to 50% by weight, preferably from 5 to 40% by weight, in particular from 10 to 40% by weight.

In order to obtain better compatibility of the fibrous fillers, and particularly of the continuous fibers, with the thermoplastic polymer, the fibrous fillers, particularly the continuous fibers, can have been surface-pretreated with a silane compound.

Suitable silane compounds are those of the general formula

(X—(CH₂)ₙ)ₖ—Si—(O—CₘH₂ₘ₊₁)₄₋ₖ

in which the definitions of the substituents are as follows:

X: NH₂—,

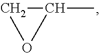

### HO—

n: an integer from 2 to 10, preferably from 3 to 4
m: an integer from 1 to 5, preferably from 1 to 2
k: an integer from 1 to 3, preferably 1

Preferred silane compounds are aminopropyltrimethoxysilane, aminobutyltrimeth-oxysilane, aminopropyltriethoxysilane, aminobutyltriethoxysilane, and also the corresponding silanes which comprise a glycidyl group as substituent X. The amounts generally used for surface-coating in the silane compounds are from 0.01 to 2% by weight, preferably from 0.025 to 1.0% by weight, and particularly from 0.05 to 0.5% by weight (based on the mass of the fibers).

It is preferable that, in addition to use of additives, the thermoplastic polymer is also selected to correspond to the temperature to which the component has exposure in service.

Other additives which can be comprised within the polymer are kaolin, calcined kaolin, wollastonite, talc, and chalk, acicular mineral fillers, and/or lamellar or acicular nanofillers, preferably in amounts of from 0.1 to 10% by weight. Materials particularly suitable here are: boehmite, bentonite, montmorillonite, vermiculite, hectorite, and laponite. The nanofillers can be organically modified for good compatibility with the thermoplastic polymer.

Other additives which can be comprised within the thermoplastic polymer are the following, preferred respective amounts being from 0.05 to 3% by weight, preferably from 0.1 to 1.5% by weight: antioxidants, dyes, lubricants, and Cu stabilizers, for example Cu(I) halide, particularly in a mixture with an alkali metal halide or with a sterically hindered phenol.

Other conventional additives are elastomeric polymers, which are also termed impact modifiers, elastomers, or rubbers, in a proportion of up to 25% by weight, preferably up to 20% by weight.

Conventional processing aids can moreover also be comprised. These are by way of example stabilizers, oxidation retarders, agents to counteract decomposition by heat and decomposition by ultraviolet light, lubricants and mold-release agents, and colorants, such as dyes and pigments, nucleating agents, plasticizers, etc.

In one embodiment of the invention, the component further comprises a cap made of a thermoplastic polymer which closes the hollow body. If the hollow body has more than one aperture, all of the apertures can be closed by a respectively suitable cap. However, it is also possible that at least one aperture is closed and at least one aperture is not closed. Particularly if there is a requirement that components located in the interior of the hollow body be accessible from outside even after mounting and after closure, it is preferable not to close all of the apertures with a cap.

One embodiment of the invention here can use, as cap, a second hollow body that can be subjected to internal pressure and that is open on one side.

In order to close the at least one aperture with a cap, it is particularly preferable to achieve interlock connection between the cap and the hollow body. By way of example, an interlock connection can be realized via an adhesion process or welding process. It is particularly preferable that the cap is likewise manufactured from a thermoplastic polymer and is connected to the hollow body via a welding process. Ultrasound welding processes are an example of suitable welding processes for connecting the hollow body to the cap. It is particularly preferable that the same thermoplastic polymer is used as material for the cap and for the hollow body.

Another possible alternative, alongside the adhesive bonding or welding of the cap to the hollow body, is to use an injection-molding process to mold the cap by way of example directly on the hollow body or to use a compression process, such as flow molding or compression molding, to connect the cap to the hollow body.

Another possibility moreover, alongside interlock connection of the hollow body to a cap, is to connect further add-on parts, or else reinforcement ribs, to the hollow body, to the extent that these are required. The reinforcement ribs or the add-on parts are likewise preferably attached here via an adhesion process, welding process, or compression process, for example flow molding or compression molding, or are molded on in an injection-molding process.

In order to use the continuous-fiber-reinforced thermoplastic polymer to produce a hollow body which can be subjected to internal pressure it is possible by way of example, in a first operation, to use the continuous-fiber-reinforced thermoplastic polymer to manufacture a sheet, by first introducing plies of the continuous fibers within a suitable mold. As described above, it is possible here to use the continuous fibers in the form of individual plies of parallel fibers or in the form of woven or knit. Once the fibers have been inserted, the thermoplastic polymer is charged to the mold. By way of example, a casting process is used here, for example injection molding.

To produce the hollow body that can be subjected to internal pressure, the sheet can then be molded by a thermoforming process to give the hollow body.

The hollow body that can be subjected to internal pressure and that has the at least one aperture that extends in an axial direction can by way of example be an airbag housing, a cylinder-head cover, or a charge-air box.

It is also possible, for reinforcement, to add ribs on the hollow body that can be subjected to internal pressure. The ribs provided here for reinforcement can be molded simultaneously with the molding of the hollow body or, as an alternative, can be attached after the molding of the hollow body. If the ribs are formed simultaneously with the molding of the hollow body, they can by way of example be molded via suitable compression processes. It is also possible to mold the ribs via injection molding or injection-compression molding during the molding of the hollow body via thermoforming. It is possible to attach the ribs subsequently, for example via welding. A thermoplastic polymer is used here to form not only the hollow body but also the ribs.

If the ribs are molded via an injection-molding process or via injection-compression molding, it is preferable to use an unreinforced polymer to mold the ribs, or an injection-moldable polymer reinforced with short fibers. If the ribs are molded first and then welded onto the hollow body, it is also possible to use, as an alternative to short-fiber-reinforced polymers, long-fiber-reinforced or continuous-fiber-reinforced polymers.

The polymer material from which the ribs are formed is preferably selected in such a way that it can be welded onto, or molded onto or injection-compression-molded onto, the polymer material of the hollow body. It is particularly preferable to use the same polymer material for the hollow body and for the ribs.

1. A component comprising a hollow body that can be subjected to internal pressure, where the hollow body that can be subjected to internal pressure is open at least on one side and at least one aperture extends in an axial direction, wherein the hollow body has been manufactured from a continuous-fiber-reinforced thermoplastic polymer, where the continuous fibers have a high degree of orientation and have not been arranged peripherally in the hollow body.

2. The component according to claim 1, wherein the thermoplastic polymer has been selected from polyolefins, polyamides, polycarbonates, styrene polymers, polytetrafluoroethylene, polyaromatics, polyquinoxalines, polyquinolines, or polybenzimidazoles, polyesters, polyacrylonitrile. or polyvinyl compounds, or else a mixture thereof.

3. The component according to claim 1, wherein the fibers are glass fibers, carbon fibers, potassium titanate fibers, basalt fibers, boron fibers, or aramid fibers.

4. The component according to claim 1, wherein the continuous fibers are comprised in the form of textile or in the form of plies of parallel fibers within the continuous-fiber-reinforced thermoplastic polymer.

5. The component according to claim 1, wherein the continuous fibers are comprised in a plurality of plies made of parallel fibers within the thermoplastic polymer, where the fibers of the individual plies are not parallel to one another.

6. The component according to claim 1, wherein the thickness of the continuous-fiber-reinforced thermoplastic polymer is at most 5 mm.

7. The component according to claim 1, wherein the thermoplastic polymer has been heat-stabilized.

8. The component according to claim 1, wherein the component comprises a cap made of a thermoplastic polymer which closes the hollow body.

9. The component according to claim 8, wherein the cap has been welded to the hollow body.

10. The component according to claim 8, wherein the cap is a second hollow body that can be subjected to internal pressure and which is open on one side.

11. The component according to claim 1, which is an airbag housing, a cylinder-head cover, or a charge-air box.
